(19) United States
(12) Patent Application Publication
(10) Pub. No.: US 2026/0251077 A1
(43) Pub. Date: Aug. 27, 2026

(54) MAINTENANCE METHOD FOR GAS TURBINES

(71) Applicant: MITSUBISHI HEAVY INDUSTRIES, LTD, Tokyo (JP)

(72) Inventors: Shin KATO, Tokyo (JP); Koichi TAKAHASHI, Tokyo (JP); Kenichi ARASE, Tokyo (JP); Shinya HASHIMOTO, Tokyo (JP); Hideki OTSU, Tokyo (JP)

(21) Appl. No.: 18/862,324

(22) PCT Filed: May 10, 2023
(86) PCT No.: PCT/JP2023/017548

§ 371 Date: Nov. 1, 2024

(30) Foreign Application Priority Data
May 10, 2022 (JP) 2022-077565

(51) Int. Cl. F01D 25/00; F01D 17/16

(52) U.S. Cl. CPC F01D 25/00; F01D 5/005; F01D 17/16; F01D 17/162; F05D 2230/72

(57) ABSTRACT

According to the present disclosure, a maintenance method for a gas turbine includes: a step of preparing a third actuator, a step of detaching the first actuator and attaching the third actuator at a first inspection time; a step of performing maintenance on the first actuator; a step of detaching the second actuator and attaching the first actuator, at a second inspection time; a step of performing maintenance on the second actuator; and a step of detaching the third actuator and attaching the second actuator, at a third inspection time, in which the first actuator, the second actuator, and the third actuator have the same specifications.

### TECHNICAL FIELD

The present disclosure relates to a maintenance method for a gas turbine. Priority is claimed on Japanese Patent Application No. 2022-77565, filed May 10, 2022, the content of which is incorporated herein by reference.

### BACKGROUND ART

A gas turbine includes a compressor that compresses air to generate high-pressure air, a combustor that generates high-temperature and high-pressure combustion gas by mixing fuel with the high-pressure air and combusting the mixture, and a turbine driven by the combustion gas. The compressor has an inlet guide vane (IGV) for adjusting a flow rate of inflowing air and a variable vane for adjusting a flow direction of the air in the compressor. Each of the inlet guide vane and the variable vane is rotatably. supported around a rotation shaft extending in a radial direction with respect to a casing of the compressor. A ring that can be rotated in a circumferential direction along an outer peripheral surface of the casing is connected to the inlet guide vane and the variable vane. When the ring is rotated in the circumferential direction, each of the inlet guide vane and the variable vane can be rotated around the rotation shaft to change the posture thereof.

The above-described ring is generally driven by an actuator having a rod that advances and retracts. In order to operate the actuator, it is necessary to regularly; inspect and replace an electrical system, an internal ball screw, and the like. The following Patent Document 1 discloses a method for rotating common components at different parts when this type of gas turbine component is maintained

### CITATION LIST

### Patent Document

Patent Document 1: Japanese Unexamined Patent Application, First Publication No. 2006-264988

### SUMMARY OF INVENTION

### Technical Problem

However, the inlet guide vane and the variable vane have different performance requirements for the actuator. Therefore, it is difficult to replace the actuator between the inlet guide vane and the variable vane. As a result, there is a problem that the maintenance cost increases The present disclosure has been made in order to solve the above-described problems, and an object of the present disclosure is to provide a maintenance method for a gas turbine, which can realize cost reduction.

### Solution to Problem

To solve the above problems, according to the present disclosure, a maintenance method for a gas turbine, which includes an inlet guide vane disposed at an inlet of a compressor that is rotatably driven around an axis, and a first ring connected to the inlet guide vane, a plurality of rows of variable vanes disposed on a downstream side with respect to the inlet guide vane in a direction of the axis, and a second ring connected to the plurality of rows of variable vanes, and a first actuator and a second actuator, both of which configured to rotate the first ring and the second ring in a circumferential direction, includes: a step of preparing a third actuator different from the first actuator and the second actuator; a step of detaching the first actuator and attaching the third actuator at a predetermined first inspection time; a step of performing maintenance on the first actuator which is detached; a step of detaching the second actuator and attaching the first actuator, which has completed maintenance, at a predetermined second inspection time; a step of performing maintenance on the second actuator which is detached; and a step of detaching the third actuator and attaching the second actuator, which has completed maintenance, at a predetermined third inspection time, in which the first actuator, the second actuator, and the third actuator have the same specifications.

### Advantageous Effects of Invention

According to the present disclosure, it is possible to provide a maintenance method for a gas turbine, which can realize cost reduction

### BRIEF DESCRIPTION OF DRAWINGS

FIG. 1 A schematic view showing the configuration of a gas turbine according to an embodiment of the present disclosure.

FIG. 2 A schematic view showing the configuration of an inlet guide vane according to the embodiment of the present disclosure.

FIG. 3 A schematic view showing the configuration of a variable vane according to the embodiment of the present disclosure.

FIG. 4 A flowchart showing each step of a maintenance method for the gas turbine according to the embodiment of the present disclosure.

FIG. 5 A block diagram showing an example of rotation of an actuator according to the embodiment of the present disclosure.

### DESCRIPTION OF EMBODIMENTS

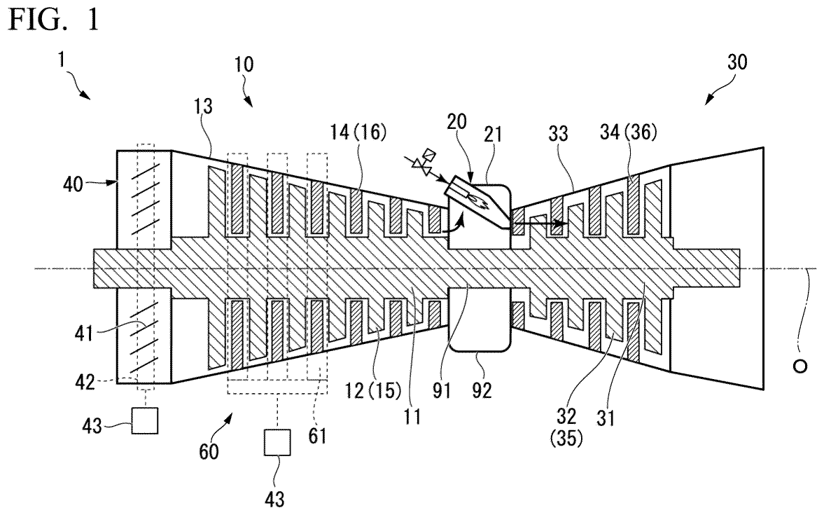

Hereinafter, a gas turbine 1 and a maintenance method for the gas turbine 1 according to an embodiment of the present disclosure will be described with reference to FIGS. 1 to 5.

### Configuration of Gas Turbine

As shown in FIG. 1, the gas turbine 1 includes a compressor 10, a combustor 20, and a turbine 30.

The compressor 10 compresses air to generate high-pressure air. The compressor 10 includes a compressor rotor 11, a plurality of compressor blade rows 12, a compressor casing 13, a plurality of compressor vane rows 14, and an inlet guide vane 40. The compressor rotor 11 has a columnar shape centered on an axis O. The compressor rotor 11 is rotatably supported around an axis O. The plurality of compressor blade rows 12 arranged at intervals in a direction of the axis O are disposed on an outer peripheral surface of the compressor rotor 11. Each of the compressor blade rows 12 includes a plurality of compressor blades 15 that extend in a radial direction and are arranged at intervals in a circumferential direction.

The plurality of compressor blade rows 12 are covered by the compressor casing 13 from an outer peripheral side. The compressor casing 13 has a tubular shape centered on the axis O. A plurality of compressor vane rows 14 arranged at intervals in the direction of the axis O are disposed on an inner peripheral surface of the compressor casing 13. Each of the compressor vane rows 14 includes a plurality of compressor vanes 16 that extend in the radial direction and are arranged at intervals in the circumferential direction.

An inlet guide vane (IGV) 40 is disposed at an inlet which is one end portion of the compressor 10 in the direction of the axis O. The inlet guide vane 40 includes a plurality of guide vanes 41, a first ring 42, and an actuator 43. The plurality of guide vanes 41 extend radially inward from the inner peripheral surface of the compressor casing 13 and are arranged at intervals in the circumferential direction

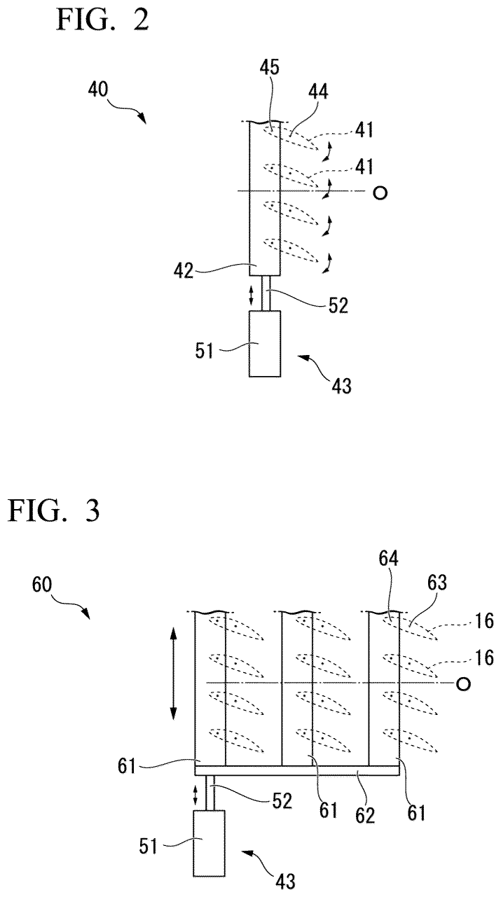

As shown in FIG. 2, a central portion of the guide vane 41 is a first rotation shaft 44 fixed to the compressor casing 13. The guide vane 41 is rotatably supported around the first rotation shaft 44. Further, the first ring 42 is connected to an end portion of the guide vane 41 on a leading edge side via a first support shaft 45. The first ring 42 forms an annular shape centered on the axis O and is rotated around the axis O. The actuator 43 is connected to the first ring 42.

The actuator 43 includes a cylinder 51 and a rod 52 having a rod shape. The rod 52 advances and retracts in a direction in which the rod 52 extends with respect to the cylinder 51. As the rod 52 advances and retracts, the first ring 42 rotates in the circumferential direction with respect to the axis O. When the first ring 42 rotates, the plurality of guide vanes 41 rotates around the first rotation shaft 44. That is, the posture of each guide vane 41 is changed.

Further, among the compressor vane rows 14, three rows of the compressor vane rows 14 are variable vanes 60 as an example. The variable vane 60 has a configuration in which the posture of the compressor vane 16 can be changed, similar to the inlet guide vane 40.

Specifically, as shown in FIG. 3, the variable vane 60 includes three second rings 61 provided for each compressor vane row 14, a connection portion 62 that connects the three second rings 61 in the direction of the axis O, and the actuator 43

A second rotation shaft 63 fixed to the compressor casing 13 is disposed at a central portion of the compressor vane 16. The compressor vane 16 is rotatably supported around the second rotation shaft 63. Further, the second ring 61 is connected to an end portion of the compressor vane 16 on the leading edge side via the second support shaft 64. The second ring 61 forms an annular shape centered on the axis O and rotates around the axis O. The actuator 43 is connected to the second ring 61 The actuator 43 used in the variable vane 60 has the same specifications and dimensional characteristics as the actuator 43 used in the inlet guide vane 40. The term “same” as used herein means “substantially same,” and individual differences in manufacturing are acceptable.

As the rod 52 advances and retracts, the three second rings 61 rotate in the circumferential direction with respect to the axis O via the connection portion 62 When the second ring 61 rotates, the plurality of compressor vanes 16 rotate around the second rotation shaft 63. That is, the posture of each compressor vane 16 is changed,

The combustor 20 is attached to an intermediate casing 21 disposed on a downstream side of the compressor casing 13 in the direction of the axis O. The combustor 20 generates high-temperature and high-pressure combustion gas by mixing fuel with the high-pressure air generated by the compressor 10 and combusting the mixture. A plurality of combustors 20 are disposed at intervals in the circumferential direction with respect to the axis O. The combustion gas generated by the combustor 20 is sent to an inside of a turbine casing 33 described below.

The turbine 30 includes a turbine rotor 31, a plurality of turbine blade rows 32, a turbine casing 33, and a plurality of turbine vane rows 34. The turbine rotor 31 has a columnar shape centered on the axis O. The turbine rotor 31 is rotatably supported around an axis O. The plurality of turbine blade rows 32 arranged at intervals in the direction of the axis O are disposed on an outer peripheral surface of the turbine rotor 31. Each of the turbine blade rows 32 includes a plurality of turbine blades 35 that extend in the radial direction and are arranged at intervals in the circumferential direction.

The plurality of turbine blade rows 32 are covered by a turbine casing 33 from the outer peripheral side. The turbine casing 33 has a tubular shape centered on the axis O. A plurality of turbine vane rows 34 arranged at intervals in the direction of the axis O are disposed on an inner peripheral surface of the turbine casing 33. Each turbine vane row 34 has a plurality of turbine vanes 36 that extend in the radial direction and are arranged at intervals in the circumferential direction.

The compressor rotor 11 and the turbine rotor 31 described above are integrally connected to each other on the axis O to form a gas turbine rotor 91. The compressor casing 13, the intermediate casing 21, and the turbine casing 33 are integrally connected in the direction of the axis O to form a gas turbine casing 92. That is, the gas turbine rotor 91 is integrally rotatable around the axis O in the gas turbine casing 92.

When the gas turbine rotor 91 is rotated by a motor (not shown) or the like, air is taken into the compressor 10. The flow rate of the air taken into the compressor 10 is controlled by the posture of the inlet guide vane 40. The high-pressure air is generated by driving the compressor 10. The flow rate of the high-pressure air generated by the compressor 10 is controlled by the posture of the variable vane 60.

The high-pressure air generated by the compressor 10 is sent from the compressor casing 13 to the combustor 20 of the intermediate casing 21. The combustor 20 generates high-temperature and high-pressure combustion gas by mixing fuel with the high-pressure air and combusting the mixture. The combustion gas is sent into the turbine casing 33 to give rotational energy to the turbine rotor 31. The gas turbine 1 is operated by continuously performing such an operation.

### Maintenance Method for Gas Turbine

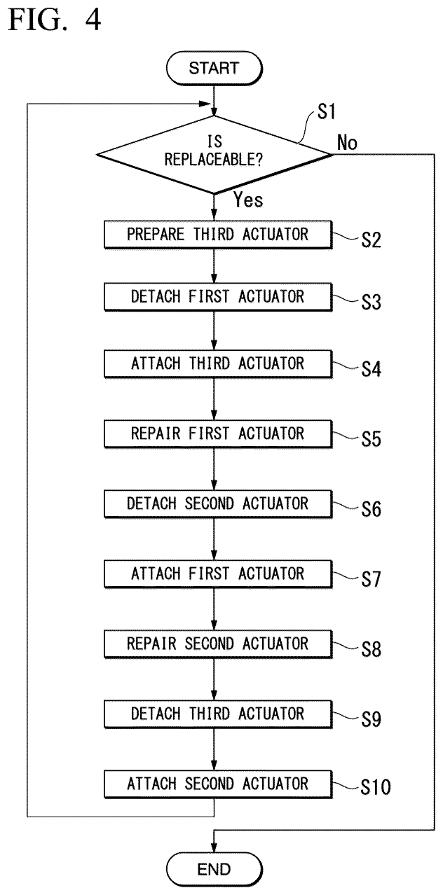

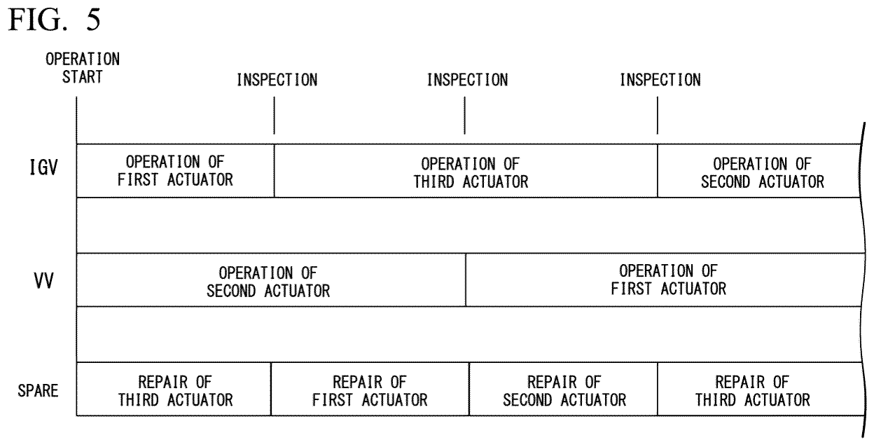

Subsequently, a maintenance method for the gas turbine 1 will be described with reference to FIGS. 4 and 5. The maintenance method relates to rotation (replacement) of the actuator 43 used in the inlet guide vane 40 and the variable vane 60 described above.

As shown in FIG. 4, in this maintenance method, first, it is determined whether the actuator 43 is in a replaceable state (step S1). When it is determined that the actuator 43 is not in the replaceable state (step S1: No), the process ends. When it is determined that the actuator 43 is in the replaceable state (Step S1: Yes), the process proceeds to subsequent step S2. As described above, one actuator 43 is used for each of the inlet guide vane 40 and the variable vane 60. In step S2, a third actuator 43 having the same specifications as the two actuators 43 is prepared.

In the following description and FIG. 5, the actuator 43 initially attached to the inlet guide vane (IGV) 40 is referred to as a “first actuator”, the actuator 43 attached to the variable vane (VV) 60 is referred to as a “second actuator”, and the third actuator 43 prepared in step S2 is referred to as a “third actuator”. These three actuators 43 are sequentially used only in the same gas turbine 1.

In subsequent step S3, the first actuator is detached from the inlet guide vane 40 at a predetermined first inspection time. In this case, as shown in FIG. 5, the second actuator continues to operate as the variable vane 60. In addition, the third actuator has completed repair (maintenance) by the first inspection time.

After the first actuator is detached, the third actuator is attached to the inlet guide vane 40 (step S4). Accordingly, the third actuator is put into operation. The detached first actuator is repaired (Step S5). When the length of a period in which the repair of the first actuator is allowed is 1, the length of a period in which the remaining two actuators 43 are put into operation is 2.

Next, when a predetermined second inspection time is reached, the second actuator is detached (step S6). In this case, as shown in FIG. 5, the third actuator continues to operate as the inlet guide vane 40. In addition, the first actuator has completed the repair (maintenance) by the second inspection time.

After the second actuator is detached, the first actuator is attached to the variable vane 60 (step S7). Accordingly, the first actuator is put into operation. The detached second actuator is repaired (step S8). When the length of the period in which the repair of the second actuator is allowed is 1, the length of the period in which the remaining two actuators 43 are put into operation is 2.

Thereafter, when a predetermined third inspection time is reached, the third actuator is detached (step S9). In this case, as shown in FIG. 5, the first actuator continues to operate as the variable vane 60. In addition, the second actuator has completed the repair (maintenance) by the third inspection time

After the third actuator is detached, the second actuator is attached to the inlet guide vane 40 (step S9). Accordingly, the second actuator is put into operation. The detached third actuator is repaired (Step S10). When the length of the period in which the repair of the third actuator is allowed is 1, the length of the period in which the remaining two actuators 43 are put into operation is 2.

Each of the steps from step S2 to step S10 is continuously performed until it is determined in step S1 that the actuator 43 is not in the replaceable state.

### Effect

In this case, in order to perform the maintenance of the gas turbine 1, it is important to ensure stability of the operation of the actuator 43 be described above. In order to operate the actuator 43, it necessary to regularly inspect and replace an electrical system, an internal ball screw, and the like. However, the inlet guide vane 40 and the variable vane 60 have different performance requirements for the actuator. Therefore, it is difficult to replace the actuator 43 between the inlet guide vane 40 and the variable vane 60. As a result, there is a problem that the maintenance cost increases. Therefore, in the present embodiment, the specifications of the actuators 43 attached to the inlet guide vane 40 and the variable vane 60 are commonized. Specifically, the specifications of the actuators 43 are disposed to the variable vane 60 which requires a larger thrust. Accordingly, since the actuator 43 can be operated while rotating between the inlet guide vane 40 and the variable vane 60, it is possible to reduce the cost.

Further, by preparing the third actuator 43 in addition to the two actuators 43 used in the first ring 42 and the second ring 61, it is possible to provide the remaining one actuator 43 for spare including the maintenance step while any two of the three actuators 43 are in operation. In other words, the specifications are commonized, so that only one actuator 43 is required as spare. Accordingly, it is possible to realize a reduction in the number of components, a reduction in maintenance cost, and a shortening of a period required for the maintenance.

In addition, according to the method, all steps after the step of preparing the third actuator are continuously repeated. Therefore, the three actuators 43 sequentially rotate, and thus the gas turbine 1 can more stably operate for a long period of time.

In addition, according to the method, the length of the period in which one of the first actuator, the second actuator, and the third actuator is provided as spare is half of the length of the per od in which two of the actuators 43 e used for operation.

Accordingly, it is possible to stagger the use periods of two actuators 43 that are used for operation. Therefore, the number of actuators 43 to be replaced in one maintenance can be set to only one. In other words, the number of actuators 43 provided as spare can be limited to one, Accordingly, the number of components can be reduced, and the maintenance cost and period can be further reduced as compared with a case where the two actuators 43 are replaced at the same time,

In addition, according to the method, the three actuators 43 are sequentially used only in the same gas turbine 1. Accordingly, a change in a load on the actuator 43 due to the individual difference for each gas turbine 1 is suppressed. Therefore, it is possible to continue to operate the three actuators 43 for a long period of time in a stable environment. In addition, since the same gas turbine 1 individual is used, it is easy for a worker to predict deterioration and failure caused by each actuator 43 in the individual. As a result, it is possible to reduce the burden on the maintenance of the worker.

### Other Embodiments

As described above, the embodiment of the present disclosure has been described in detail with reference to the drawings, but the specific configuration is not limited to this embodiment, and includes design changes and the like without departing from the scope of the present disclosure.

For example, in the above-described embodiment, an example in which the three actuators 43 are sequentially applied to only the same pas turbine 1 has been described. However, the actuators 43 can also be used through commonization between gas turbines 1 having the same model.

### APPENDIX

The maintenance method for the gas turbine 1 according to each embodiment is understood as follows, for example.
(1) According to a first aspect, a maintenance method for a gas turbine 1 including an inlet guide vane 40 disposed at an inlet of a compressor 10 that is rotatably driven around an axis O, and a first ring 42 connected to the inlet guide vane 40, a plurality of rows of variable vanes 60 disposed on a downstream side with respect to the inlet guide vane 40 in a direction of the axis O, and a second ring 61 connected to the plurality of rows of variable vanes 60, and a first actuator and a second actuator, both of which rotate the first ring 42 and the second ring 61 in a circumferential direction, the maintenance method including: a step of preparing a third actuator different from the first actuator and the s p of detaching the first actuator and attaching the third actuator at a predetermined first inspection time; a step of performing maintenance on the first actuator which is detached; a step of detaching the second actuator and attaching the first actuator, which has completed maintenance, at a predetermined second inspection time: a step of performing maintenance on the second actuator which is detached; and a step of detaching the third actuator and attaching the second actuator, which has completed maintenance, at a predetermined third inspection time, in which the first actuator, the second actuator, and the third actuator have the same specifications.

According to the method, since the specifications of the first actuator, the second actuator, and the third actuator are the same, the actuators 43 can be commonly used between the first ring 42 connected to the inter guide vane 40 and the second ring 61 connected to the variable vane 60. Further, by preparing the third actuator 43 in addition to the two actuators 43 used in the first ring 42 and the second ring 61, it is possible to provide the remaining one actuator 43 for spare including the maintenance step while any two of the three actuators 43 are in operation.
(2) According to a second aspect, a maintenance method for the gas turbine 1 is the maintenance method for the gas turbine 1 according to the first aspect in which the steps after the step of preparing the third actuator are continuously repeated.

According to the method, the three actuators 43 sequentially rotate, and thus the gas turbine 1 can more stably operate for a long period of time.
(3) According to a third aspect, a maintenance method for the gas turbine 1 is the maintenance method for the gas turbine 1 according to the first or second aspect in which, when the length of a period in which the first actuator, the second actuator, and the third actuator are attached to any one of the first ring 42 and the second ring 61 is 2, the length of a period in which the first actuator, the second actuator, and the third actuator are provided as spare including the step of performing maintenance is 1.

According to the method, the length of the period in which one of the first actuator, the second actuator, and the third actuator is provided as spare is half of the length of the period in which two of the actuators 43 are used for operation. Accordingly, it is possible to stagger the use periods of the two actuators 43 that are used for operation. Therefore, the number of actuators 43 provided as spare can be limited to one.
(4) According to a fourth aspect, a maintenance method for the gas turbine 1 is the maintenance method for the gas turbine 1 according to any one of the first to third aspects in which the first actuator, the second actuator, and the third actuator are sequentially used only in the same gas turbine.

According to the method, the three actuators 43 are sequentially used only in the same gas turbine 1. Accordingly, a change in a load on the actuator 43 due to the individual difference for each gas turbine 1 is suppressed.

### REFERENCE SIONS LIST

1 . . . Gas turbine
10 . . . Compressor
11 . . . Compressor rotor
12 . . . Compressor blade row
13 . . . Compressor casing
14 . . . Compressor vane row
15 . . . Compressor blade
16 . . . Compressor vane
20 . . . Combustor
21 . . . Intermediate casing
30 . . . Turbine
31 . . . Turbine rotor
32 . . . Turbine blade row
33 . . . Turbine casing
34 . . . Turbine vane row
35 . . . Turbine blade
36 . . . Turbine vane
40 . . . inlet guide vane
41 . . . Guide vane
42 . . . First ring
43 . . . Actuator
44 . . . First rotation shaft
45 . . . First support shaft
51 . . . Cylinder
52 . . . Rod
60 . . . Variable vane
61 . . . Second ring
62 . . . Connection portion.
63 . . . Second rotation shaft
64 . . . Second support shaft
91 . . . Gas turbine rotor
92 . . . Gas turbine casing
O . . . Axis

1-4. (canceled)

5. A gas turbine comprising:
an inlet guide vane disposed at an inlet of a compressor that is rotatably driven around an axis, and a first ring connected to the inlet guide vane;
a plurality of rows of variable vanes disposed on a downstream side with respect to the inlet guide vane in a direction of the axis, and a plurality of second rings corresponding to each of the plurality of rows and connected to the variable vane constituting each row; and
a first actuator rotating the first ring in a circumferential direction, and a second actuator rotating the plurality of second rings in the circumferential direction, wherein the first actuator and the second actuator have the same specifications.

6. A maintenance method for the gas turbine according to claim 5 comprising:
a step of detaching the first actuator and attaching a third actuator at a first inspection time;
a step of detaching the second actuator and attaching the first actuator, which has completed maintenance, at a second inspection time; and
a step of detaching the third actuator and attaching the second actuator, which has completed maintenance, at a third inspection time.

7. A maintenance method for the gas turbine according to claim 5 comprising:
a step of detaching the second actuator and attaching a third actuator at a first inspection time;
a step of detaching the first actuator and attaching the second actuator, which has completed maintenance, at a second inspection time; and
a step of detaching the third actuator and attaching the first actuator, which has completed maintenance, at a third inspection time.

8. The maintenance method for the gas turbine according to claim 6, wherein the steps are sequentially and continuously repeated.

9. The maintenance method for the gas turbine according to claim 7, wherein the steps are sequentially and continuously repeated.

10. The maintenance method for the gas turbine according to claim 6, further comprising:
a step of performing maintenance on the first actuator which is detached; and
a step of performing maintenance on the second actuator which is detached.

11. The maintenance method for the gas turbine according to claim 7, further comprising:
a step of performing maintenance on the first actuator which is detached; and
a step of performing maintenance on the second actuator which is detached.

12. The maintenance method for the gas turbine according to claim 6,
wherein the first actuator, the second actuator, and the third actuator are sequentially used only in the same gas turbine.

13. The maintenance method for the gas turbine according to claim 7,
wherein the first actuator, the second actuator, and the third actuator are sequentially used only in the same gas turbine.

14. The maintenance method for the gas turbine according to claim 6,
wherein the third actuator has the same specifications as the first actuator and the second actuator.

15. The maintenance method for the gas turbine according to claim 7,
wherein the third actuator has the same specifications as the first actuator and the second actuator.
